(19) United States
(12) Patent Application Publication
(10) Pub. No.: US 2020/0408583 A1
(43) Pub. Date: Dec. 31, 2020

(54) NOVEL FOAM-LEVEL-DETECTION TECHNOLOGY

(71) Applicant: Probe Technology Services, Inc., Fort Worth, TX (US)

(72) Inventors: Rich Thibodeaux, Humble, TX (US); Kent Dawson, Houston, TX (US)

(73) Assignee: Probe Technology Services, Inc., Fort Worth, TX (US)

(21) Appl. No.: 16/458,067

(22) Filed: Jun. 30, 2019

(51) Int. Cl. G01F 23/62; G01F 23/76

(52) U.S. Cl. CPC G01F 23/62; G01F 23/76

(57) ABSTRACT

A foam-level detector is disclosed. The foam-level detector includes mesh disposed on one or more arms attached to a carrier. The carrier is configured to engage a tube so as to be slidable along the longitudinal axis of the tube. The mesh is configured to engage a foam layer such as to float at or near the surface of the foam. The arms may be pivotally attached to the carrier. The carrier may include a magnet configured to magnetically engage a magnet disposed in the tube. The magnet in the tube may be configured to electrically connect two materials, each material having an electrical resistance per unit length of the material. A measure of the resistance of the conductive path formed by the magnet in the tube and the two materials may be used to infer the position of the foam-float along the tube.

### BACKGROUND

This invention pertains generally to the detection of fluid levels in a tank or pit or similar vessel (collectively, “tank”), such as a process or storage tank. More specifically, the invention is directed to technology for measuring and monitoring the level of foam in a tank, alone or in conjunction with measuring and monitoring the level(s) of other fluid(s) in the tank. For example, the technology is useful for measuring the foam level in an oilfield tank used to store fluids produced from a well or fluids used to drill the well.

Storage of liquids in a tank or passage of liquids through a tank is often accompanied by the generation of foam comprising gas pockets trapped in liquid films. This foam may present an impediment or danger to the process, the equipment, the environment, or personnel. Properly addressing the presence of foam can provide cost-saving, quality-improvement, safety, and environmental advantages. Detection of the level of foam in a tank (e.g., the distance from the top of the foam to the top or bottom surface of the tank) can provide valuable information for addressing the presence of foam. Likewise, detection of the depth of the foam (e.g., the distance from the top of the foam to the foam-liquid interface) can provide valuable information for addressing the presence of foam.

Accordingly, there is a need for technology to determine the position of the top of a foam layer in a tank (the level of the foam). This technology may be used in conjunction with other technology for determining the top of a liquid layer in a tank. For example, determining the positions of the top of the foam layer and the foam-liquid interface provides information about the thickness of the foam layer.

### SUMMARY

The present invention is directed to technology to satisfy the need to detect the level of foam in a tank.

In one aspect of the invention, a foam-level detector includes a foam-float comprising a mesh disposed on one or more arms attached to a carrier that is configured to engage an elongate structure such as a tube or rod so as to be able to slide along the structure in the structure's longitudinal direction. The foam-float is configured to present an area of mesh to a foam and, when placed in the foam, to engage the foam so as to float at or near the surface of the foam. In use, the foam-float can be disposed on a tube (or similar structure) that in turn is vertically disposed in a tank. The foam-float will float on the top surface of any foam layer in the tank and will slide along the longitudinal axis of the tube in concert with changes in the foam's level. Thus, an indication of position of the foam-float relative to the tube provides information about the level of the top surface of the foam layer in the tank. The arm(s) of the foam-float may be pivotally attached to the carrier such that the cross-sectional area of the foam-float may be changed by pivoting the arms. This may be used, for example, to reduce the cross-sectional area sufficient to insert the foam-float through a hole in a tank. The pivotally attached arm(s) may be biased toward a position that presents a large cross-sectional area through, for example, springs attached to the arm(s) and carrier. The foam-float may include a magnet that can be used to provide a mechanical or electronic indication of the position of the carrier along a tube (or similar structure) on which the carrier is disposed.

In another aspect of the invention, a foam-float includes a magnet that may be magnetically coupled to a second magnet. The magnetic coupling of the foam-float's magnet and the second magnet causes the second magnet to move in concert with the foam-float's magnet. Thus, the position of the second magnet indicates the position of the foam-float. The second magnet may be mechanically coupled to an indicator like a rod or flag such that movement of the second magnet is reflected in movement of the indicator to indicate the position of the foam-float. The second magnet may be used to electrically couple two conductive materials each having a resistance per unit length such that a measure of the resistance of the electrically coupled materials indicates the position of the foam-float. This resistance may be measured by measuring the current through and voltage drop across the electrically coupled materials.

In another aspect of the invention, a foam-float may be combined with a liquid-float configured to float on a particular liquid but not on the foam. For example, a liquid-float may be designed to float at or near the surface of an oil layer that is directly below the foam layer. In conjunction, the liquid-float and foam-float may be used to determine the positions of the top of the oil layer and the top of the foam layer. This combination of liquid-float and foam-float provides information regarding the thickness of the foam layer and the level of the foam.

### BRIEF DESCRIPTION OF THE DRAWINGS

These and other features, aspects, and advantages of the present invention will become better understood with reference to the following description, appended claims, and accompanying drawings where:

FIG. 1 illustrates a multi-fluid-level detector including an exemplary foam-level detector according to an aspect of the invention.

FIG. 2 is a functional schematic of an exemplary resistivity-based level-detection circuit for use with a foam-level detector according to an aspect of the invention.

FIG. 3 is a simplified functional schematic of an exemplary resistivity-based level-detection circuit for use with a foam-level detector according to an aspect of the invention.

FIG. 4 illustrates float and sensor components of an exemplary foam-level detector according to an aspect of the invention.

FIG. 5 illustrates float components of an exemplary foam-level detector according to an aspect of the invention.

FIG. 6 illustrates float components of an exemplary foam-level detector according to an aspect of the invention.

FIG. 7 is a functional schematic of an exemplary resistivity-based level-detection circuit for use with a multi-fluid-level detector including a foam-level detector according to an aspect of the invention.

FIG. 8 is a functional schematic of an exemplary resistivity-based level-detection circuit for use with a multi-fluid-level detector including a foam-level detector according to an aspect of the invention.

FIG. 9 is a functional schematic for an exemplary control and communications circuit for use with a foam-level detector according to an aspect of the invention.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

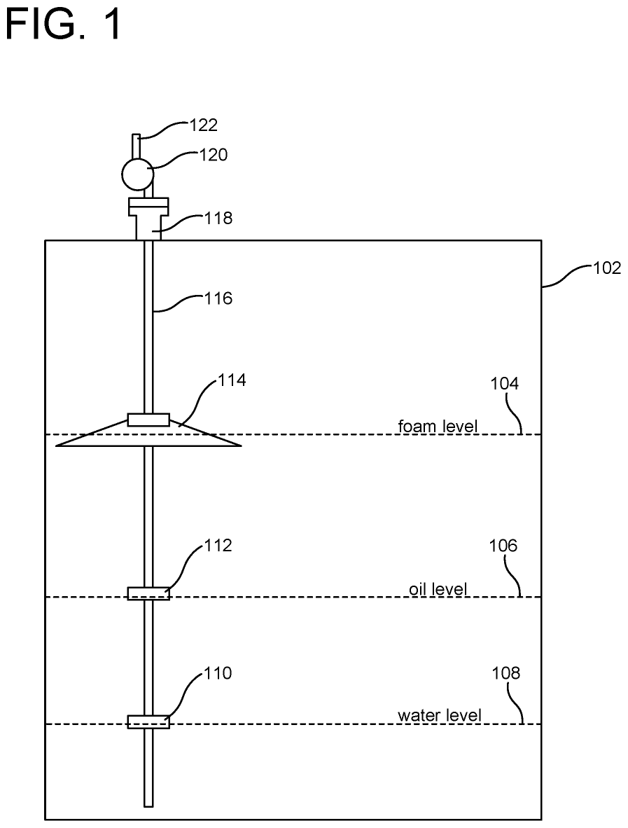

FIG. 1 illustrates an exemplary foam-level detector disposed in a tank along with other fluid-level detectors. A foam-level-detector float 114 (the foam-float) is shown disposed in a tank 102 deployed around a tube 116 such that the foam-float 114 may slide relative to the longitudinal axis of tube 116. The tube 116 is mounted to the tank through a flange 118. Two other floats are also depicted in the figures: an oil-float 112 and a water-float 110. Each deployed to slide along the tube 116. The foam-float 114 is configured such that it is sufficiently buoyant with respect to foam that it floats at or near the upper surface of the foam layer 104. The oil-float 112 is configured such that it will not float on the foam but will float on or at the surface of oil 106. The water-float 110 is configured such that it will not float on the foam or the oil, but will float on or at the surface of the water 108. Floats may be configured for various liquids by, e.g., selecting or creating a material with the appropriate specific gravity for the liquid.

The tube 116 may include mechanical or electrical assemblies to convey the position of the foam float 114. For example, the foam-float 114 may include a magnet that magnetically engages a magnet in the tube 116. The magnet in the tube may be mechanically connected to a mechanical indicator (e.g., a rod or flag) the position of which is a function of the tube-magnet's position in the tube 116 which is in turn a function of the foam-float-magnet's position with respect to the tube 116. The position of the tube-magnet may instead or also be determined electronically.

In the embodiment of FIG. 1, the position of each float 110, 112, 114 is determined and displayed electronically through control and display circuitry 120. The position information may be wirelessly communicated utilizing an antenna 122.

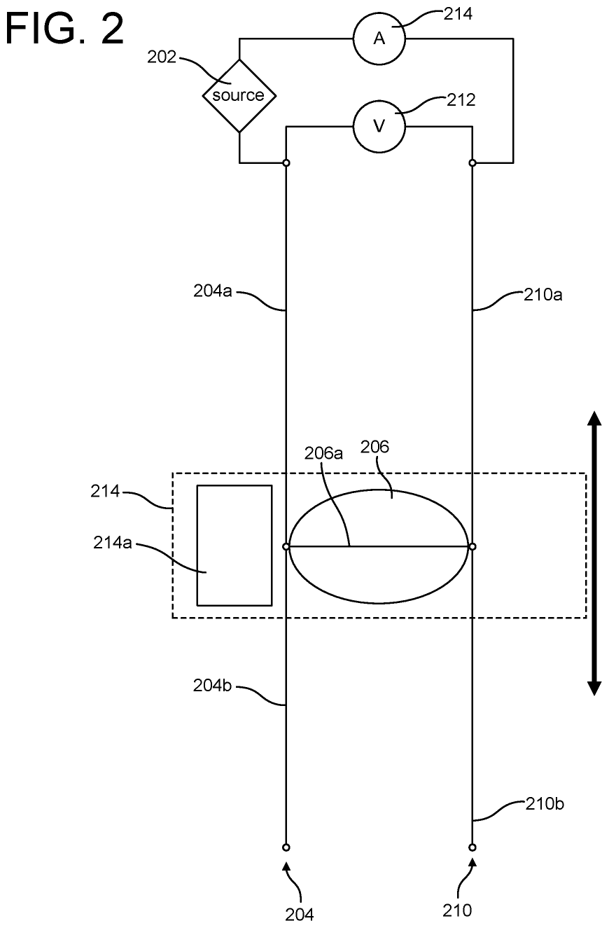

FIG. 2 illustrates an exemplary electrical circuit for determining the position of a foam-float. The foam-float includes a carrier 214 that is or includes a float-magnet 214a. (The carrier 214 is illustrated in dashed lines to show that other parts/features are viewed through the carrier 214.) The carrier 214 is configured to fit over a tube (not shown) and in slidable engagement with the tube, as described with reference to the embodiment of FIG. 1. A tube-magnet 206 is deployed in the tube such that it is magnetically engaged with the float-magnet 214a. Sliding the carrier 214 up or down along the tube will cause the tube-magnet 206 to slide up or down within the tube such that the position of the tube-magnet 206 corresponds to the position of the float-magnet 214a.

Two elongate resistive structures 204, 210, each having an electrical resistance per unit length, are deployed along the longitudinal axis of the tube. (The resistive structures 204, 210 may be, e.g., metal wires or traces; semiconductor traces, rods, or tubes; or conductive tape.) The tube-magnet 206 includes a contact 206a that electrically connects one resistive structure 204 to the other 210. This forms a current path comprising a first resistive portion 204a, the contact 206a, and a second resistive portion 210a. The resistance of this current path is a function of the lengths of the first and second resistive portions 204a, 210a. The lengths of the first and second resistive portions 204a, 210a are a function of the position of the tube-magnet 206 which is a function of the position of the carrier 214 which is a function of the position of the foam-float which is a function of the position of the top of the foam layer on or in which the foam-float is floating. Thus, a measure of the position of the foam-float (and thus the position of the top of the foam layer) may be determined by measuring the resistance of the current path formed by the first resistive portion 204a, the contact 206a, and the second resistive portion 210a. Preferably, the resistance per unit length of the resistive structures 204, 210 is such as to provide measurable changes in resistance for significant changes in foam-float position. For example, if the position of the top of the foam layer should be known within 1 cm, the resistance per unit length should be high enough that a 1 cm difference in the foam-float position yields statistically different measures of resistance.

The resistance of the current path formed by the first resistive portion 204a, the contact 206a, and the second resistive portion 210a may be measured using an ohmmeter in any form. For example, a circuit that provides a known current through the current path for a known voltage drop across the current will yield information about the resistance of the current path (via Ohm's law). This can be accomplished using a power source 202 to provide a current through the current path and measuring the current with an ammeter 214 and measuring the voltage with a voltmeter 212. The current and voltage measurements may then be displayed or stored, and may be converted to a foam-float position based on a theoretically-derived or calibration-based equation.

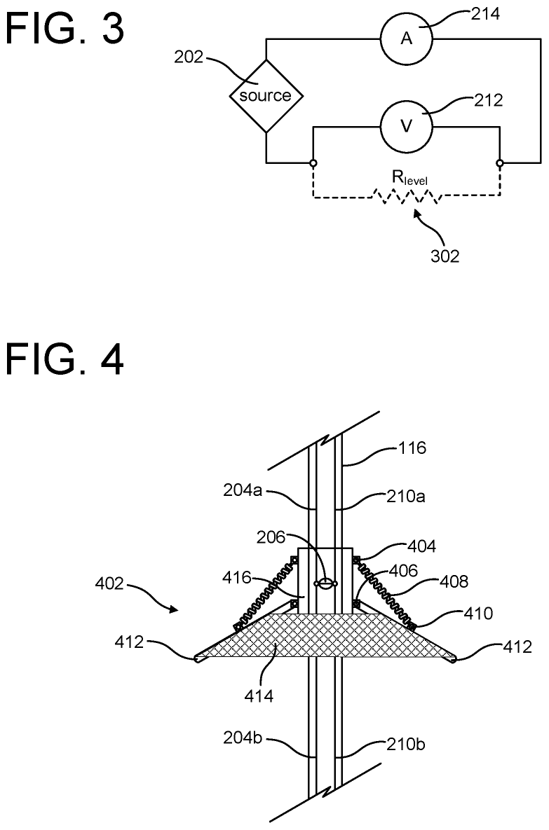

FIG. 3 is a simplified illustration of the circuit of FIG. 2. As shown, the level of the float corresponds to a resistance Rₗₑᵥₑₗ 302. A measure of the value of the resistance Rₗₑᵥₑₗ 302 provided by, e.g., substantially simultaneous measures of current through the resistance 302 (with ammeter 214) and voltage across the resistance 302 (with voltmeter 212), provides an indication of the level of the float and thus the level of the fluid in which the float is floating.

FIG. 4 illustrates float and sensor components of an exemplary foam-level detector. A foam-float 402 includes a carrier 416, arms 412, and a mesh 414 (shown in cross-hatch). The arms 402 are attached to the carrier 416 and the mesh 414 is attached to the arms 402. The carrier 416 fits over a tube 116 and, as described above, is slidably engaged with the tube 116. Two resistive structures 204, 210 and a tube-magnet 206 are provided in the tube, as described above with reference to FIG. 2. The carrier 416 includes or is a foam-float-magnet similar to the foam-float-magnet 214a described above with reference to FIG. 2.

The arms 412 are connected to the carrier 416 such as to present a cross-sectional area of the mesh 414 to the top of a foam layer. The mesh is configured to allow liquids to pass through it but to have enough buoyancy to float on or in the foam. The buoyancy is a function of the size and density of the mesh openings, the cross-sectional area of the mesh interfacing with the foam, and the weight of the of the foam-float 402. For example, a stainless-steel mesh of 0.012″ wires and 30 openings per inch that presents roughly 540 square inches of mesh when the arms 412 are at 90 degrees to the carrier 416 has been found sufficient for use in tanks holding oil and water.

The foam-float magnet of the carrier 416 engages a tube-magnet 206 deployed in the tube 116. The tube-magnet 206 moves with the foam-float 402 to create current paths of resistive portions 204a, 210a as described with reference to FIG. 2 above. The position of the foam-float 402 corresponds to the top of the foam layer.

As depicted in FIG. 4, the arms 412 may be pivotally attached to the carrier 416 at pivot points 406. This allows the cross-sectional area of the foam-float 402 to be reduced by pivoting the arms 412 toward parallel with the tube 116. This can be useful when the float must fit through an opening smaller than the arm-extended-configuration of the foam-float 402. For example, this allows deployment of the foam-float 402 into tanks through bores in the tank (e.g., a flange opening) much smaller than the length of the arms 412.

As depicted in FIG. 4, springs 408 may be used to bias the foam-float 402 to the arm-extended configuration. For example, extension springs 408 may connect the arms 412 to the carrier 416 at points above the pivot points 406 (as shown). The springs 408 will provide a force tending to pivot the arms 412 up. The carrier 416 or the pivot points 406 may include stops to prevent the arms 412 from pivoting past 90 degrees to the carrier 416. Other spring types may be used. For example, compression springs may be installed to push the arms 412 up. Similarly, torsion or constant-force springs may be installed to rotate the arms 412 up.

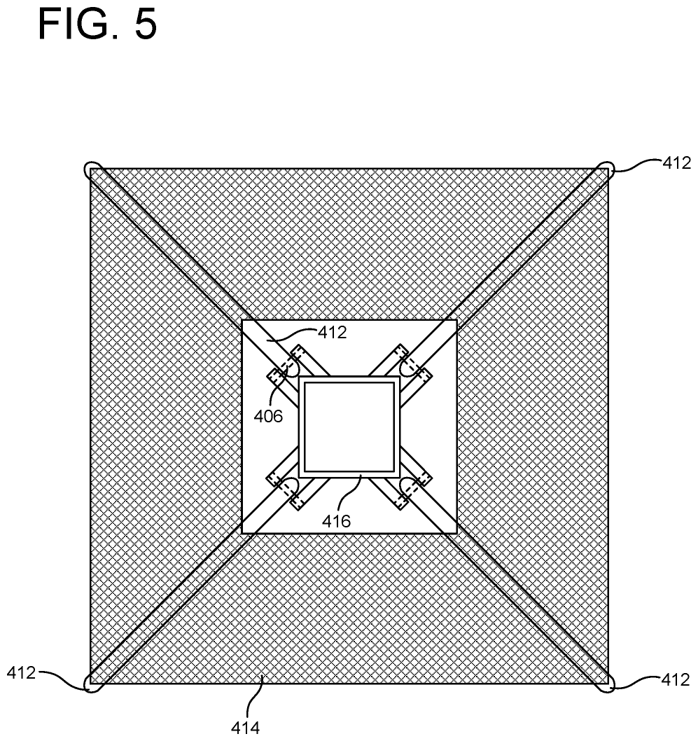

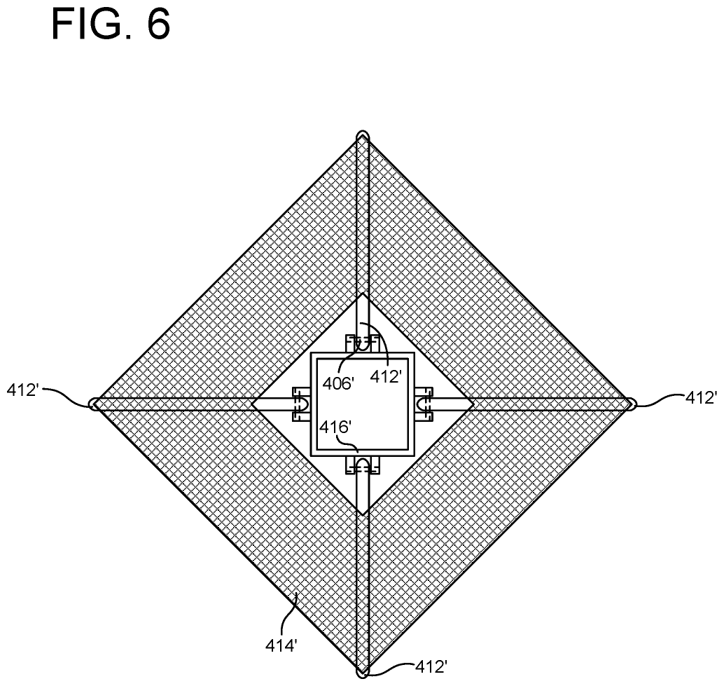

FIG. 5 illustrates float components of an exemplary foam-level detector. This figure depicts a top view of the mesh 414 and arms 412 in the arm-extended configuration. (The arms 412 are shown at roughly 90 degrees to the carrier 416.) In this embodiment, the pivot points 406 are at the corners of a square carrier 416. The pivot point 406 may be positioned elsewhere. For example, the embodiment depicted in FIG. 6 shows the arms 412′ attached to the carrier 416′ at pivot points 406′ on the faces of the square carrier 416′. The carrier 416 is not necessarily limited to a square profile. For example, the carrier 416 may equivalently have a circular, triangular, or other profile. Similarly, the foam-float 402 is not necessarily limited to four arms 412. More or fewer arms may be used. Similarly, the mesh 414 is not necessarily limited to a quadrilateral profile.

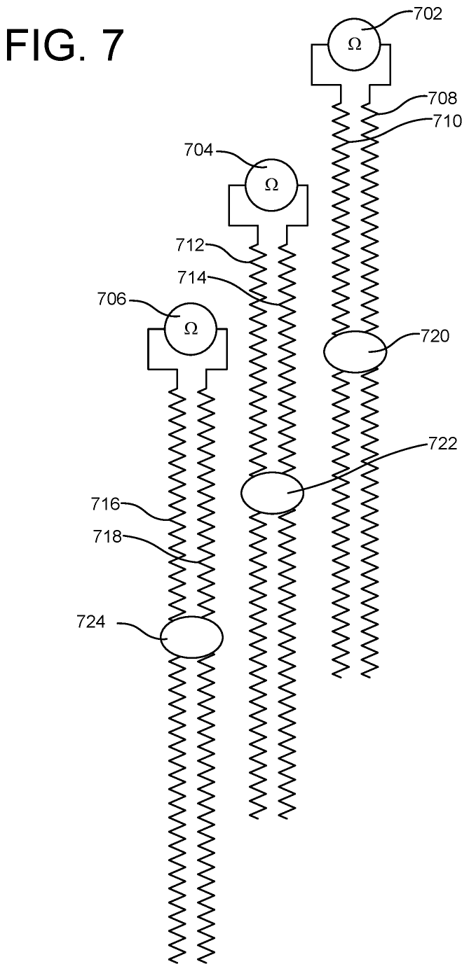

FIG. 7 is a functional schematic of an exemplary system for detecting the different levels of different fluids in a single tank. In this embodiment, three floats (not shown) each separately correspond to one of three tube-magnets 720, 722, 724. Each of the three tube magnets 720, 722, 724 each separately corresponds to one of three resistive-structure pairs 708/710, 712/714, 716/718. Each of three ohmmeters 702, 704, 706 separately corresponds to one of the three resistive-structure pairs 708/710, 712/714, 716/718. Each system of ohmmeter, resistive-structure pair, and tube-magnet functions as described with reference to FIG. 2 to provide a resistance measurement indicative of the position of the tube-magnet which is indicative of the float position which is indicative of the position of the top surface of a particular layer. For example, the first tube-magnet 720 may correspond to a foam-float, the second tube-magnet 722 may correspond to an oil-float, and the third tube-magnet 724 may correspond to a water-float. Thus, the resistance measured by the first ohmmeter 702 corresponds to a position of the top of the foam layer, the resistance measured by the second ohmmeter 704 corresponds to a position of the top of the oil layer, and the resistance measured by the third ohmmeter 702 corresponds to a position of the top of the water layer. Such a system may be used to provide information about the position of the top of the foam layer as well as the depth of the foam layer (among other information).

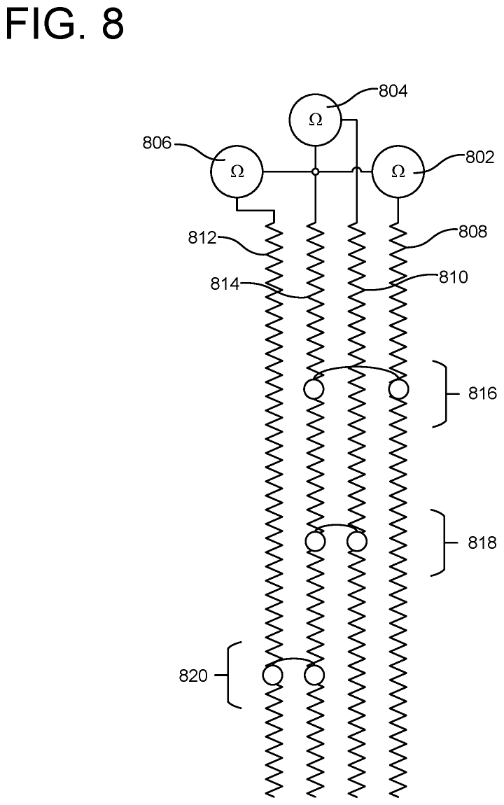

FIG. 8 is a functional schematic of an exemplary system for detecting the different levels of different fluids in a single tank. This embodiment is similar to the FIG. 7 embodiment with the exception that the resistive-structure pairs are formed using a common resistive structure 814. Thus, the first resistive-structure pair 808/814, first ohmmeter 802, and first tube-magnet 816 provide a measure of the position of a first float. The second resistive-structure pair 810/814, second ohmmeter 804, and second tube-magnet 818 provide a measure of the position of a second float. And the third resistive-structure pair 812/814, third ohmmeter 806, and third tube-magnet 820 provide a measure of the position of a third float.

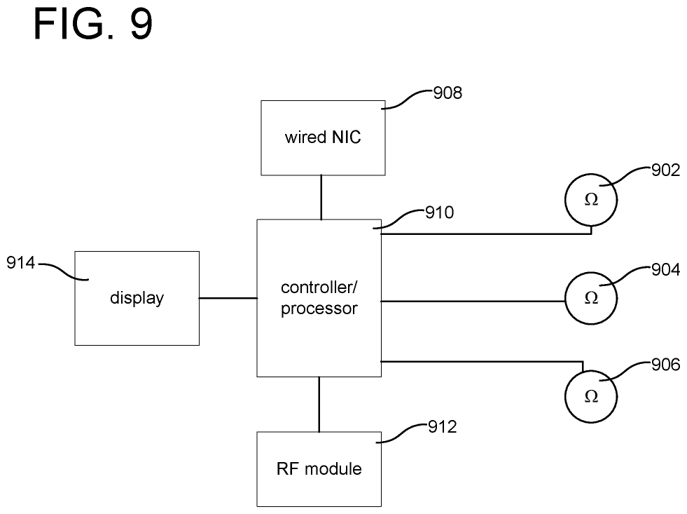

FIG. 9 is a functional schematic of an exemplary system for acquiring and communicating fluid-level information. Resistance data corresponding to a foam-float position is provided by an ohmmeter 902. The information is conventionally collected and processed by a controller (or processor) 910. The controller/processor 910 may conventionally display the information on a display 914 such as a screen or panel. The controller/processor 910 may conventionally communicate the information through, e.g., a wired-network-interface 908 or a wireless interface 912 such as Wi-Fi, Bluetooth, or cellular. One or more additional ohmmeters 904, 906 may be used to register the position of other floats.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A foam-level detector comprising:
(a) a carrier configured to slidably engage an elongate tube, the carrier having a sliding axis;
(b) an arm attached to the carrier;
(c) a mesh attached to the arm; and
(d) a float-magnet.

2. The foam-level detector of claim 1 wherein the arm is attached to the carrier at a pivot point.

3. The foam-level detector of claim 2 further comprising a spring, wherein the spring is connected to the arm and the carrier such as to bias the arm toward the position that is 90 degrees from the sliding axis.

4. The foam-level detector of claim 3 wherein the spring is one of the group consisting of an extension spring, a compression spring, a torsion spring, and a constant-force spring.

5. The foam-level detector of claim 1 further comprising:
(a) an elongate tube having a longitudinal axis, wherein the carrier is slidably engaged with the tube so that the sliding axis is substantially parallel to the longitudinal axis;
(b) a tube-magnet disposed within the tube, wherein the tube-magnet is magnetically coupled to the float-magnet;
(c) a first material having a resistance per unit length, wherein the first material is disposed within the tube; and
(d) a second material having a resistance per unit length, wherein the second material is disposed within the tube; and
(e) wherein the tube-magnet electrically couples the first material to the second material, thereby creating a conductive path having a resistance per unit length.

6. The foam-level detector of claim 5 further comprising an ohmmeter, wherein the ohmmeter is connected to the first material and the second material such as to provide a measure of the resistance of the conductive path formed by the first and second materials as electrically coupled by the tube-magnet.

7. The foam-level detector of claim 5 wherein the first material's resistance per unit length is substantially the same as the second material's resistance per unit length.

8. A fluid-level-detection system comprising:
(a) a foam-float comprising a carrier, an arm, a mesh, and a magnet;
(b) a tube;
(c) a first tube-magnet disposed within the tube, wherein the first tube-magnet is magnetically coupled to the foam-float's magnet; and
(d) a means for determining the position of the first tube-magnet.

9. The fluid-level detection system of claim 8 further comprising:
(a) a first liquid-float comprising a carrier and a magnet;
(b) a second tube magnet, wherein the second tube-magnet is magnetically coupled to the first liquid-float's magnet; and
(c) a means for determining the position of the second tube-magnet.

10. The fluid-level detection system of claim 9 further comprising:
(a) a second liquid-float comprising a carrier and a magnet;
(b) a third tube magnet, wherein the third tube-magnet is magnetically coupled to the second liquid-float's magnet; and
(c) a means for determining the position of the third tube-magnet.

11. A method for detecting a foam layer in a tank, the method comprising:
(a) disposing on a tube in a tank a foam-float comprising a carrier, an arm, a mesh, and a foam-float magnet;
(b) disposing in the tube in the tank, a first resistive material, a second resistive material, and a tube-magnet, wherein the tube-magnet electrically couples the first resistive material to the second resistive material to create a conductive path;
(c) magnetically coupling the foam-float magnet to the tube-magnet;
(d) providing a measure of the resistance of the conductive path formed by the first and second resistive materials as electrically coupled by the tube-magnet; and
(e) providing a measure of the position of the foam-float based on the measure of the resistance.
